(19) United States
(12) Patent Application Publication
(10) Pub. No.: US 2007/0143530 A1
(43) Pub. Date: Jun. 21, 2007

(54) Method and apparatus for multi-block updates with secure flash memory

(76) Inventors: John C. Rudelic, Folsom, CA (US); August Camber, Rocklin, CA (US); Sujaya Srinivasan, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/303,162

(22) Filed: Dec. 15, 2005

(51) Int. Cl. G06F 12/00

(52) U.S. Cl. 711/103

(57) ABSTRACT

Method and apparatus for multi-block update using secure flash memory. An update package is received at a device containing update code to update existing code for the device stored in non-volatile memory. The received update code is stored in a first portion of the non-volatile memory, while pointers identifying storage locations of respective sets of the update code are written to a second portion of the non-volatile memory device. An update process is then performed with the update code by using the pointers to locate the respective sets and assembling the update code. Updated firmware and software images are then written to the non-volatile memory device to complete the update.

### TECHNICAL FIELD

The present disclosure relates generally to wireless communications systems, and more particularly, to methods and apparatus for providing a means to update software through wireless updates.

### BACKGROUND

Mobile communication devices include non-volatile memory to persistently store software and data. Updates to the software are sometimes preferred or required to correct errors or to upgrade code already stored in non-volatile memory. These updates are authenticated by the mobile communication device to verify the origin of the incoming software update. Improvements are needed in the methods used to receive and process incoming updates to allow large file size updates to be stored without sacrificing security or memory space.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a mobile communications device in communication with a service provider to receive an update to the non-volatile memory in accordance with the present invention;

FIG. 2 illustrates how differences between two versions of firmware are compared in the creation of a differential (diff) file;

FIG. 3 is a flowchart that describes a method for updating code in a non-volatile memory system;

FIG. 4 is a flowchart that describes an example of how an incoming update can be authenticated, parsed, and organized using a temporary patch block to track the locations and lengths of a collection of diff file sets;

FIG. 5 illustrates how a patch block can be used to track the fragmentation and storage of diff file sets in non-volatile memory data blocks;

FIG. 6 illustrates the authentication process between the service provider and the flash client;

FIG. 7 illustrates the use of unique keys for accessing memory locations within the code blocks;

FIG. 8 is a flowchart that describes the method used to track and apply changes from the diff file set to the permanent code storage location while preserving the initial code in a separate memory location; and

FIG. 9 illustrates the steps used to update the code blocks of the non-volatile memory device while tracking the progress of the update process in the patch block.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

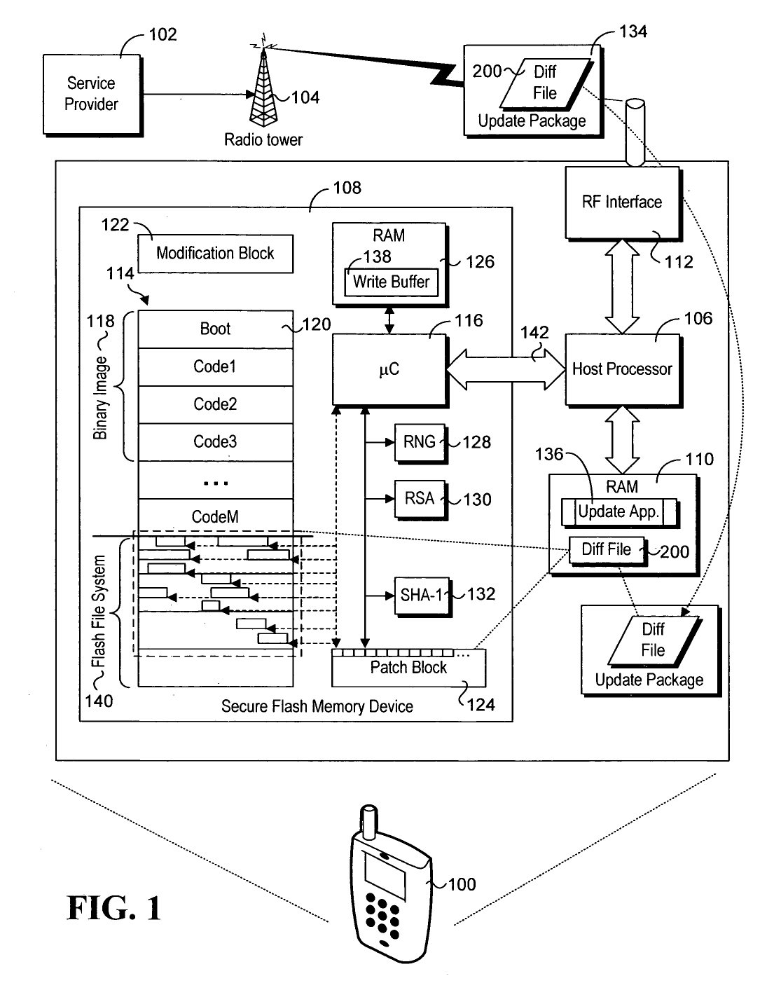

FIG. 1 illustrates an exemplary embodiment of the present invention that includes a mobile wireless communications device 100 (hereinafter mobile device) in communication with a service provider 102 through a radio tower 104. Mobile device 100 is generally illustrative of various types of mobile wireless devices, such as cellular phones, personal digital assistants (PDAs), pocket PCs, handheld computer devices, etc. Mobile device 100 includes a host processor 106 coupled to each of a secure flash memory device 108, random access memory (RAM) 110, and a radio frequency (RF) interface 112. The RF interface 112 includes radio hardware to support wireless communications using radio signals and corresponding protocols defined by one or more wireless standards. For example, if the mobile device 100 comprises a cellular phone, the RF interface would include radio hardware to support cellular-based communications using an appropriate cellular standard. In other embodiments, other wireless communication standards may be employed, such as but not limited to communications defined by the Institute of Electrical Institute of Electrical and Electronic Engineers (IEEE) 802.11, Wireless Fidelity (Wi-Fi) and IEEE 802.16 Worldwide Interoperability for Microwave Access (WiMAX) suites of standards.

Secure flash memory device 108 includes a flash memory array 114 that is accessed via a microcontroller (μC) 116, which in turn is coupled to the host processor 106. The flash memory array 114 is physically partitioned into a plurality of flash memory blocks, as is known in the art. In turn, the flash memory blocks are logically partitioned into code blocks and data blocks. A binary image 118 corresponding to the device's firmware is stored in the code blocks, which begins at a boot block 120. Add-on applications (e.g., downloaded carrier applications that were not included with the mobile device) may also be stored in the code blocks. For use herein, the code corresponding to such add-on applications is referred to as software, while the code supporting basic device operations is referred to a firmware. The data blocks are generally used to store application (firmware and software) data. As employed herein, the data blocks are used to provide storage corresponding to a flash file system 140 that operates in a manner similar to a conventional disk file system.

The memory blocks in the flash memory array 114 also include a modification block 122 and a patch block 124. Although these two blocks are shown as separate blocks for illustrative purposes, it will be understood that under a typical implementation the flash memory blocks on the secure flash memory device 108 will be physically grouped as a single array of memory blocks. The secure flash memory device 108 further includes a RAM 126 coupled to the microcontroller 116.

In one embodiment, the secure flash memory device 108 includes components to support security measures with respect to firmware updates. These components include a random number generator (RNG) 128, an RSA (Rivest, Shamir, and Adelman) engine 130, and a secure hash algorithm (SHA-1) block 132.

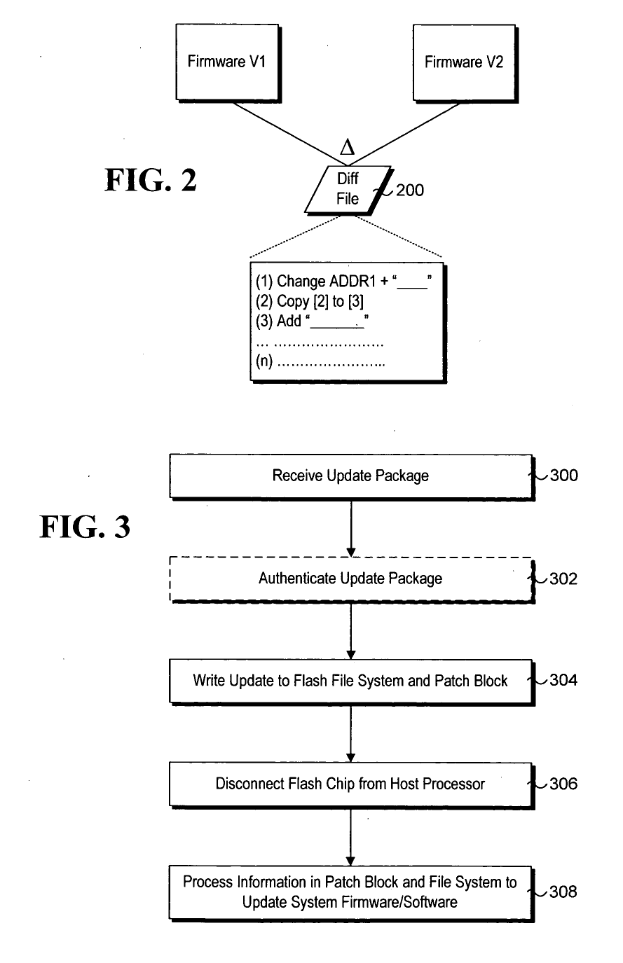

The firmware (e.g. the binary image 118) on the mobile device 100 may be updated during ongoing operations. One technique that may be employed for this purpose is to perform an over the air (OTA) transfer of an entire update firmware image to a mobile device targeted for an update. However, this generally requires transfer of a large file, which both consumes bandwidth and requires adequate spare storage available on the device being updated. Rather than transferring an entire file, the service provider 102 may generate a diff file, which contains portions of update code and instructions for updating an existing binary image to an updated binary image. This is schematically depicted in FIG. 2, wherein a diff file 200 contains update code and instructions for updating a firmware binary image from a version 1 (Firmware V1) to a version 2 (Firmware V2). The diff file 200 is preferred to reloading an entire updated version of firmware code because the file size of a diff file can be significantly smaller than the file size of the updated binary image. As a result, the transfer of a diff file from a service provider to a mobile device can occur very quickly when compared to the OTA transfer of the entire updated file. Although FIG. 2 depicts a particular diff file, the methods and apparatus described herein may be implemented with other suitable differential files.

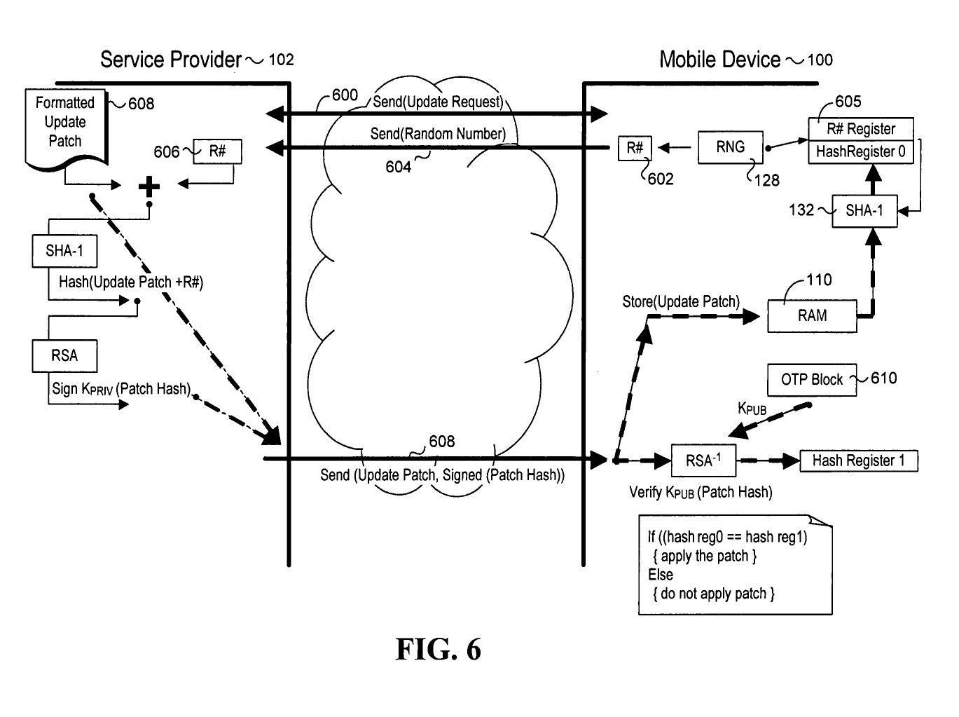

FIG. 3 shows a high-level flowchart illustrating general operations for performing a firmware update for the mobile device 100 in accordance with one embodiment of the invention. With reference to FIG. 1 and FIG. 3, the process begins in a block 300, wherein an update packet 134 including a diff file 200 is received at the RF interface 112 of the mobile device 100 as an incoming data stream. The host processor 106 then processes the data stream and stores the update package in RAM 110. In addition to the diff file 200, the update package 134 may typically include other data related to the update. In some embodiments, the update package 134 may include security data by which the update packet 134 may be authenticated, as shown in an optional block 302. For example, the update package 134 may include a diff file comprising a manifest that is digitally signed using the private key of service provider 102 or an originator of the mobile device firmware. In this case, a corresponding public key stored on the mobile device 100 may be retrieved, and the digital signature may be verified using well-known public key infrastructure (PKI) techniques, as described below in further detail below with reference to FIG. 6.

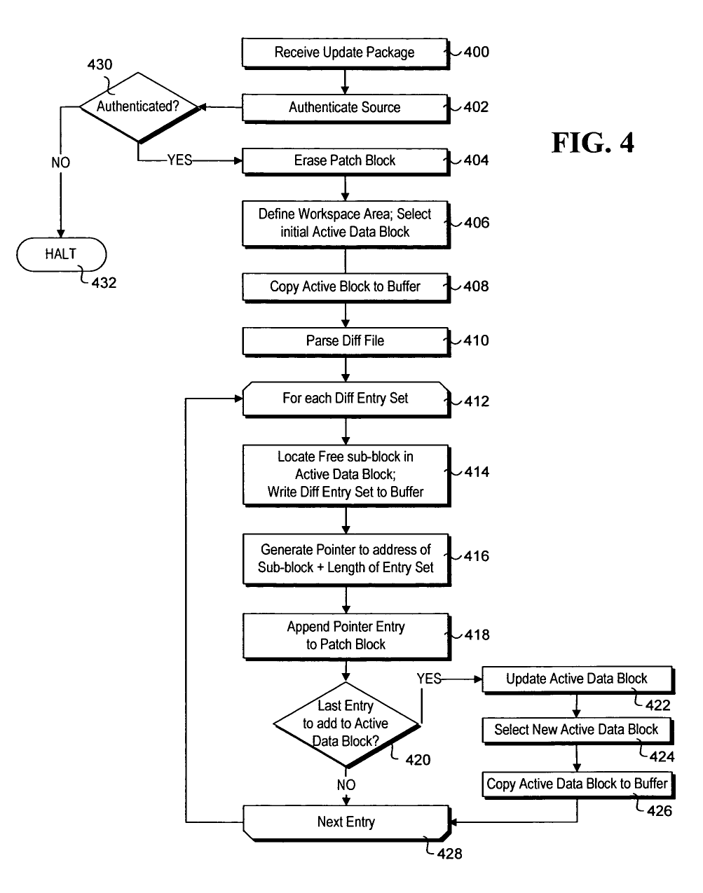

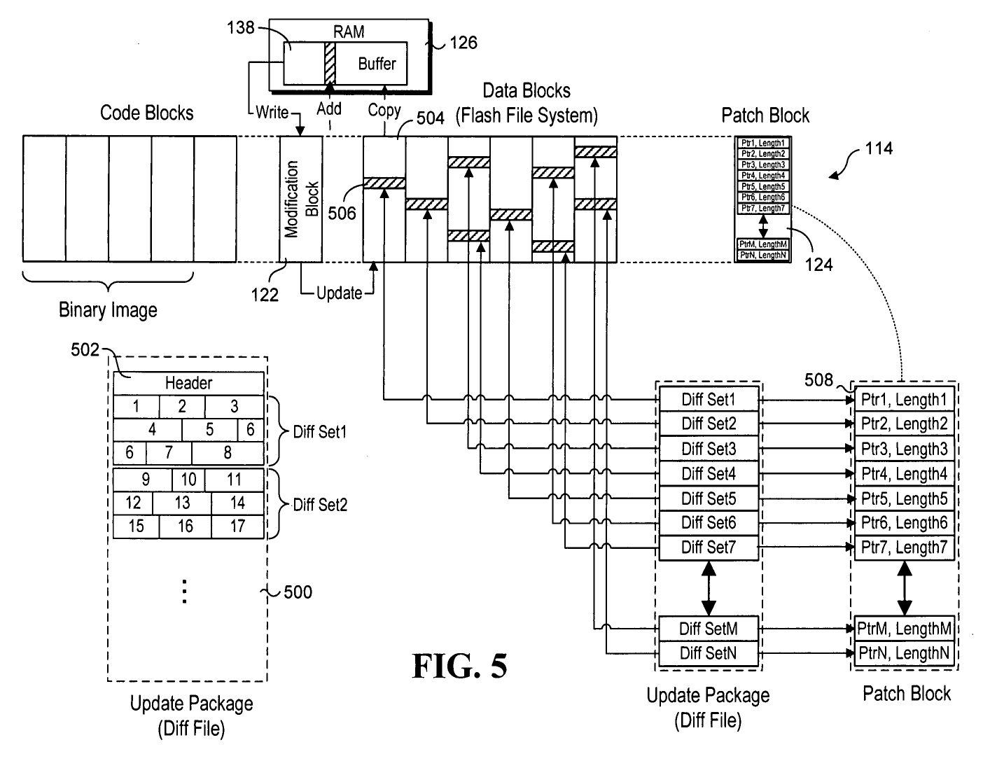

After being authenticated (if authentication is performed), data corresponding to the diff file is written to the flash file system 140 and patch block 124, as shown in block 304. This is facilitated via execution of an update application 136 on the host processor 106, which has previously been retrieved from the secure flash memory device 108 and loaded in RAM 110. During this process, various diff file entries are written to flash memory blocks in the flash file system 140, while corresponding pointers to those diff file entries are written to patch block 124, as described below in further detail with reference to FIG. 4 and FIG. 5.

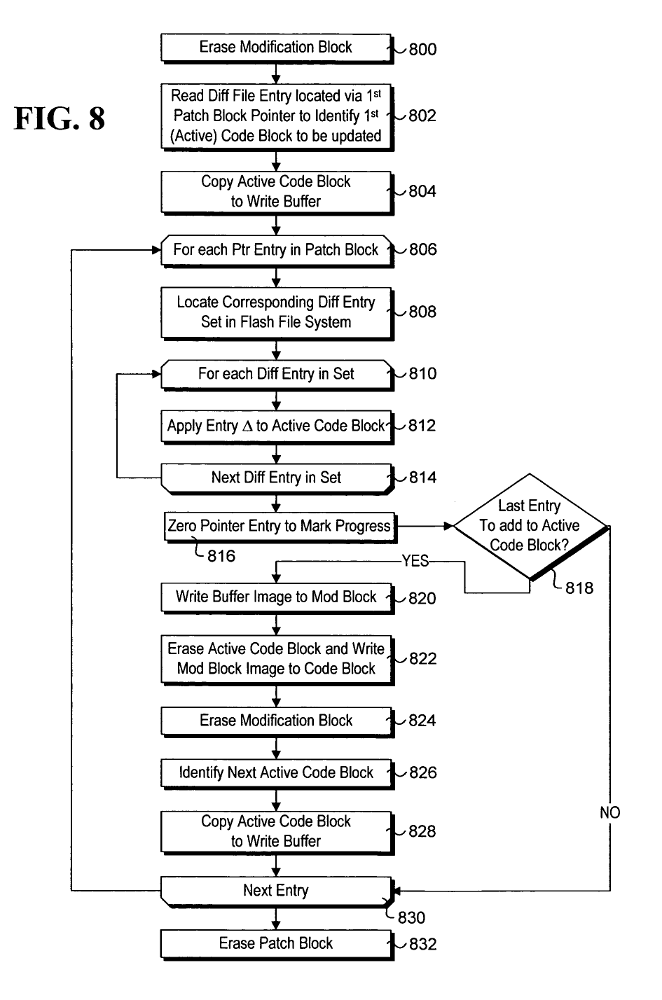

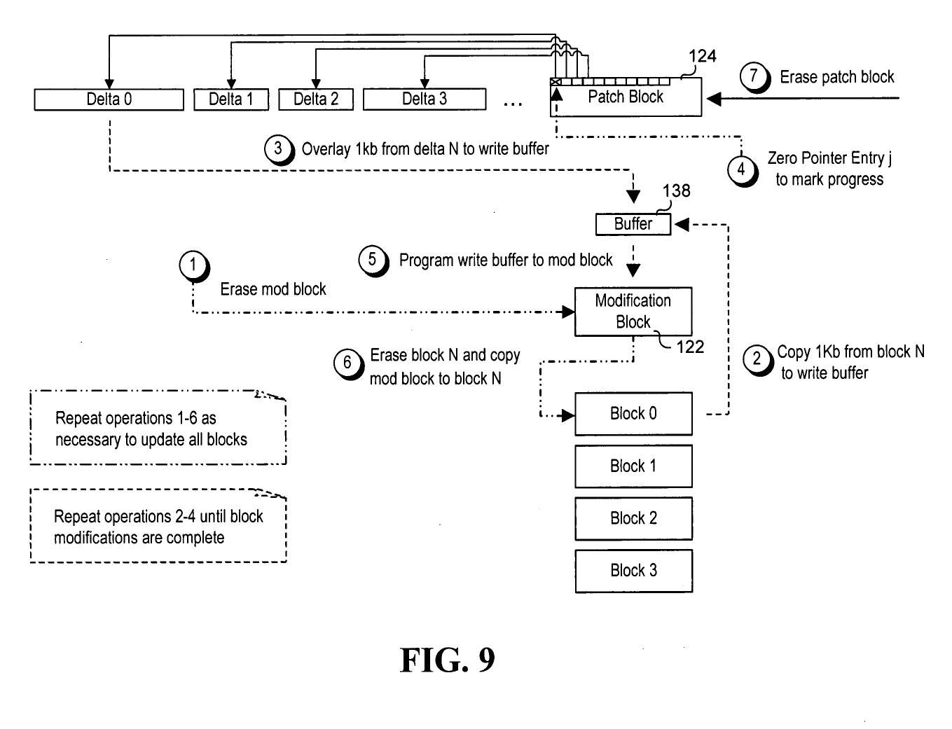

In a block 306, the secure flash memory device is “disconnected” from host processor 106. Rather than physically disconnecting the secure flash memory device 108 from the host processor 106, the interface 142 (e.g., address and data bus lines) between the secure flash memory device 108 and the host processor 106 are operatively disabled to facilitate the disconnection operation. The process is completed in a block 308, wherein the information in the patch block 124 and flash file system 140 are processed using the microcontroller 116 to update the systems firmware and/or software. This operation is described in further detail below with reference to FIG. 8 and FIG. 9.

With reference to FIG. 4, one embodiment of the operation of block 304 proceeds as follows. As before, the update package is received and loaded into RAM 110 in a block 400. In a block 402, the source of the update package is authenticated using the aforementioned security components. If the source cannot be authenticated in a block 430, the update process is halted in a block 432.

The remaining operations illustrated in FIG. 4 pertain to writing data to the flash file system 140 and patch block 124. One advantage of flash memory over RAM is that it is non-volatile, meaning the data remains after power is removed to the flash memory structure. However, unlike RAM, individual bits in flash memory blocks may not be “flipped” back and forth between a ‘1’ and a ‘0’ to change the data. Rather, individual bits may be only flipped one way, either from a ‘1’ to a ‘0’ or from a ‘0’ to a ‘1’. All of the bits in the corresponding data block may be erased to return a bit to a previous state. This is accomplished by switching all of the bits to the flash device's erase state either a ‘1’ (NAND and NOR type) or a ‘0’.

As discussed above, pointers to diff file entries are to be written to the patch block 124. Accordingly, the patch block 124 is first erased in a block 404. In a block 406, the workspace area in the flash file system 140 to be employed to facilitate the update is defined. An initial active data block in the flash file system 140 is then selected and copied into a write buffer 138 in the RAM 126, as depicted in a block 408. This operation replicates an image of the active data block. Notably, since the image is now in the RAM 126, individual bits in the data block corresponding to the image may be switched.

In a block 410, the diff file is parsed for diff entry sets. As shown in FIG. 5, an incoming diff file 500 comprises a header 502 containing information pertaining to the update, which may include a digital signature to be used for authentication purposes, as well as other data identifying what existing firmware/software the update is for. The diff file also comprises a plurality of diff entry sets (depicted as diff sets in FIG. 5), or segments, sized appropriately for convenient storage in sub-blocks within the data blocks in the flash memory array 114. Each diff entry set has a base address (i.e., the address of the beginning of the diff entry set) and a length. The diff file contains appropriate delineators to define the beginning and end of each diff entry set so that the diff entry sets may be easily parsed.

Turning back to FIG. 4, as depicted by start and end loop blocks 412 and 428, the operations shown within these loop blocks are performed for each diff entry set. First, in a block 414, a free sub-block in the active data block is located that has an adequate size to store the current diff entry set. As described above, the flash file system 140 is used to store data relating to applications running on the mobile device 100. For example, such data might include entries for a phone book or the like. The flash file system 140 operates in a similar manner to the file system used on a hard disk drive for a conventional operating system. The storage area on the disk drive is divided into logical blocks each having a logical block address (LBA) and a fixed size (e.g., 512 bytes). Similarly, the storage area of the flash file system 140 is divided into logical blocks (referred to herein as sub-blocks to differentiate between these blocks and the “data blocks” in a flash memory array). Also like a disk file system, the data stored in the flash memory file system may be stored in a discontiguous manner. Thus, a free sub-block represents a logical sub-block (or multiple sub-blocks, if required) that is marked as free (i.e., unused) in a data block.

Once the free block is located, the diff entry set is written to the free block in the corresponding image in write buffer 138. A pointer to the base address of the sub-block and the length of the diff entry set is then generated in a block 416, and a corresponding pointer entry is appended to the end of existing data in patch block 124, as depicted in a block 418. Further details of this are discussed below with reference to FIG. 5.

In a decision block 420 a determination is made to whether the current entry is the last entry to add to the active data block. For example, a search of the active data block image in write buffer 138 might be performed to verify whether or not the active data block is effectively full. If the active data block is not full, and more entries can be added, the logic loops back to start loop block 412 to perform the operations of blocks 414, 416, and 418 on the next diff entry set. However, if the active data block is full, a new active data block will need to be used to store additional diff entry sets. Accordingly, the active data block in the flash file system 140 is updated in a block 422 by writing the updated image in write buffer 138 first to modification block 122, and then back to the data block from which the image was originally copied. In accordance with flash update techniques, this will involve erasing the entire block, and the writing a copy of the updated image to the data block.

Once the data block has been updated, a new active data block from among the remaining data blocks in the flash file system 140 is selected in a block 424, and an image of the new active data block is copied into the write buffer 138 in a block 426. The foregoing operations are then repeated until all of the diff entry sets have been processed in a similar manner.

Further details of the diff entry set storage and patch block pointers are illustrated in FIG. 5. As described above, each diff entry set is stored in a free sub-block of a corresponding data block in the flash file system 140. Meanwhile, in conjunction with storing a diff entry set, a corresponding pointer and length (pointer entry) is generated and appended to the patch block 124. For example, suppose that the first active block is a data block 504. An image of this data block is first copied into the write buffer 138, and then diff set 1 is added to a free sub-block 506 in the buffered image. A first pointer entry 508 comprising a pointer to the address of sub-block 506 and a length of diff set 1 (Ptr1, Length 1) is then added to the beginning of the patch block 124, as illustrated. Similar operations are employed to add diff entry sets and corresponding pointer entries to various data blocks in the flash file system 140.

During the update active data block operation of block 422 of FIG. 4, the updated image in the write buffer 138 is first written to the modification block 122. As before, this is accomplished by erasing the modification block 122 and then writing the image to this block. Once the image is written to the modification block 122, it is then copied to the active data block. Once it is verified that the updated image has been successfully written to the active data block, a marker is updated to reflect that the update process has successfully processed diff entry sets up to that point.

The reason for the foregoing write sequence is so that there will always be at least one image in the flash memory array that is valid, such that a full recovery can be made from any state in the event of a power failure. For example, if a power failure occurs while the updated image is being written to the write buffer 138 or the updated image is being written to the modification block 122, the process is simply started over from the last successful point that is marked.

As discussed above, in some embodiments an authentication operation is performed to authenticate the update package or the diff file. One embodiment of an authentication process is shown in FIG. 6. The process begins with a message exchange 600 between the service provider 102 and the mobile device 100 to send an update. In response, the mobile device 100 employs the random number generator 128 to generate a random number 602, which is sent to service provider 102 via a message 604. A copy of the random number is also stored in a random number register 605. Upon receipt of random number 602, it is appended to a formatted update patch 606, to form a manifest. An SHA-1 hash is then performed on the manifest, and then this resulting hash is digitally signed using the private key (K_{PRIV}) of service provider 102 using an appropriate RSA encryption algorithm.

The update patch and signed patch hatch is then returned via a message 608 to the mobile device 100, where the information will be authenticated and stored. Prior to loading the updated patch in the flash memory array, the mobile device 100 verifies the authenticity of the file using a public key it previously received that is stored in a one time program (OTP) block 610. The public key is used to verify the digital signature of the patch hash to determine if the file originated from a trusted source (in this case, the service provider 102). An RSA decryption operation is performed by RSA engine 130 using the public key on the patch hatch to yield a first hash, which is stored in a hash register 1. Meanwhile, the random number 602 generated by the mobile device 100 and sent to the service provider 102 is read from random number register 605 and appended to the update patch to form a comparison manifest. An SHA-1 hash is then performed on this manifest by SHA-1 block 132, with the result stored in a hash register 0. The data in the hash registers 0 and 1 are then compared to determine if the values match. If the value match, the update is authenticated, and the update procedure continues. Otherwise if the values do not match, the update procedure is halted.

Different security keys may be used for different types of updates. For example, device firmware is generally more important than add-on carrier applications, because the mobile device 100 may not function if a malicious firmware update is installed (while installation of an errant carrier application would merely mean that the application wouldn't work). Even more important is the boot block of a firmware update.

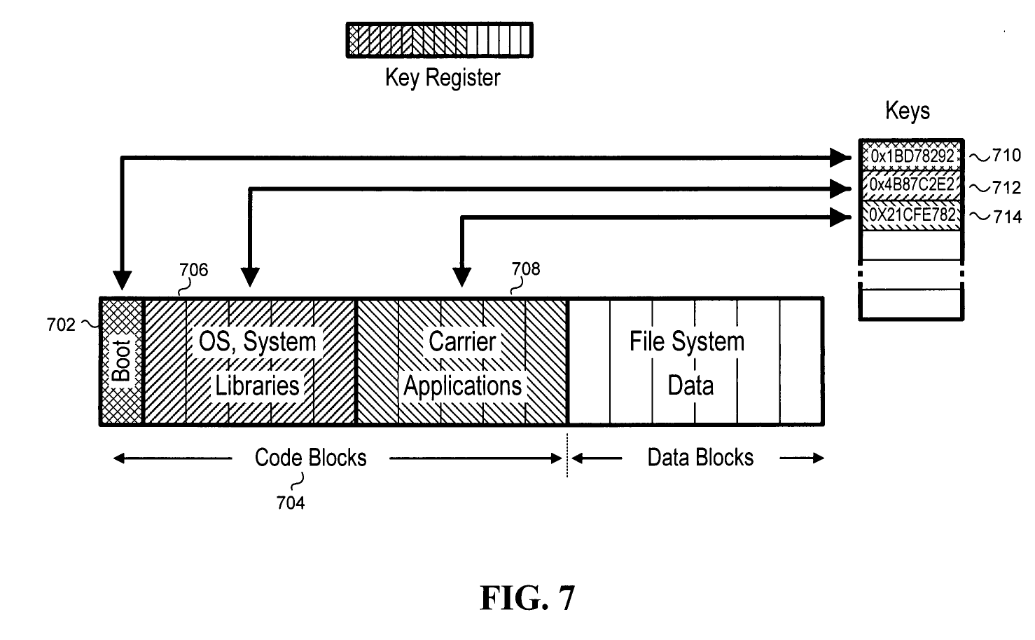

As illustrated in FIG. 7, the device's system firmware is typically configured as a boot block 702 and one or more code blocks 704 in which an operating system (OS) and system libraries 706 are stored. Meanwhile, the carrier applications 708 are stored in code blocks that are separate from those used to store the system firmware. If the boot block 702 becomes corrupted, the entire device might fail. Accordingly, in one embodiment, a separate security key 710 is used for firmware updates for updating the boot block 702. Similarly, a security key 712 is depicted for authenticating firmware updates to the OS and system libraries, and a security key 714 is depicted for software updates corresponding to carrier applications.

Once the update has been written to the flash file system 140 and patch block, the remaining code image update phase of the update process may be performed. As discussed above with reference to blocks 306 and 308 of FIG. 3, this involves disconnecting the secure flash memory device 108 from the host processor 106, and then processing the information in the patch block 124 and the flash file system 140 to update the system firmware or software, as applicable.

With reference to the flowchart of FIG. 8 and the schematic flow diagram of FIG. 9, one embodiment of the phase of the update process proceeds as follows. The process begins in a block 800 by erasing the modification block 122. In a block 802, the diff file entry located by the first patch block pointer is read to identify the first (active) code block to be updated. An image of this code block, which becomes the first active code block, is then copied into the write buffer 138 in a block 804.

As depicted by start and end loop blocks 806 and 830, the operations shown between these end loop blocks are then performed for each pointer entry in patch block 124. In a block 808, the corresponding diff entry set pointed to by the current patch block pointer is located in the flash file system 140. As depicted by start and end loop blocks 810 and 814 and block 812, for each diff entry in the set, the code portion in the entry is applied to corresponding existing code in the active code block to effect the delta (change) for the code portion. Next, in a block 816, the pointer entry is zeroed to mark progress for the update. A determination is then made in a decision block 818 to whether the current entry is the last entry to add to the active code block. If not, the logic loops back to start block 806 to process the pointer.

If the current entry is the last entry to add to the active code block, then the active code block is to be updated. This begins in a block 820, wherein the write buffer image is written to modification block 122. The active code block is then erased, and the image in modification block 122 is written to the active code block, as depicted in a block 822. The modification block is then erased in a block 824, and the next active code block is identified in a block 826 in a manner similar to that used to identify the first active code block in block 802 above. An image of the new active code block is then copied to write buffer 138 in a block 828, and the process is returned to start loop block 806 to process the next patch block pointer.

When all of the pointer entries in patch block 124 have been successfully processed, the firmware or software image in the code blocks has been successfully updated. Accordingly, the patch block is erased in a block 832 to complete the update process.

As before, this portion of the update process is performed in a manner that provides a full recovery from any failure state, such as that caused by a power failure (in the case of a mobile device, typically the battery would become discharged) or other anomaly. Furthermore, since the progress is tracked by marking the patch block pointers, an update process can be restarted from the point at which a failure occurs. Finally, by using a microcontroller that is separate from the mobile device's host processor, the update can be performed entirely by the intelligent flash chip.

The operation discussed herein may be generally facilitated via execution of appropriate firmware or software embodied as code instructions on the host processor and microcontroller, as applicable. Thus, embodiments of the invention may include sets of instructions executed on some form of processing core or otherwise implemented or realized upon or within a machine-readable medium. A machine-readable medium includes any mechanism for storing or transmitting information in a form readable by a machine (e.g., a computer). For example, a machine-readable medium can include an article of manufacture such as a read only memory (ROM); a random access memory (RAM); a magnetic disk storage media; an optical storage media; and a flash memory device, etc. In addition, a machine-readable medium may include propagated signals such as electrical, optical, acoustical or other form of propagated signals (e.g., carrier waves, infrared signals, digital signals, etc.).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
receiving an update package at a mobile device containing update code to update existing code for the mobile device stored in a flash memory device;
storing the update code in a first portion of the flash memory device;
writing pointers identifying storage locations of respective sets of the update code in a second portion of the flash memory device; and
performing an update process to update an existing code portion stored in the flash memory device with the update code by using the pointers to locate the respective sets and assemble the update code.

2. The method of claim 1, further comprising performing an authentication process on the update package to verify an originator of the update package.

3. The method of claim 2, wherein the authentication process comprises:
employing a public key stored on the mobile device to authenticate the update package by verifying the update package was signed by an originator using a private key corresponding to the public key.

4. The method of claim 1, wherein the flash memory device includes a built-in processor element to perform the update process.

5. The method of claim 1, further comprising performing the update process in a manner that is fully recoverable from any state.

6. The method of claim 1, wherein a portion of the flash memory device is used to track the locations and lengths of an update code portion.

7. The method of claim 2, wherein the update package is authenticated using a random number and public key prior to storage in the mobile device.

8. The method of claim 1, wherein the flash memory device includes a plurality of storage blocks, and the update code is stored in at least two storage blocks.

9. The method of claim 6, wherein the pointers are stored in a patch block of the flash memory device.

10. The method of claim 1, wherein the respective sets of the update code comprise differential entry sets, each differential entry set specifying a difference between a set of existing code and a set of update code used to update the existing code.

11. The method of claim 1, wherein the non-volatile memory comprises a flash memory device including multiple storage blocks, and wherein the flash update is stored in at least one storage block in a discontiguous manner.

12. The method of claim 1, wherein the mobile device comprises a wireless mobile communication device, and the update package is received by the wireless mobile communication device via a wireless transmission.

13. A mobile communications device comprising;
a flash memory client comprising;
data blocks and code blocks;
a modification block;
a patch block; and
an interface for file system management;
a buffer memory; and
a transmission path coupling the flash memory client to the buffer memory.

14. The apparatus of claim 13, wherein the mobile communications device comprises a microcontroller.

15. An apparatus comprising:
a processor;
a plurality of flash memory blocks coupled to the processor and logically partitioned into code blocks, data blocks, and a patch block; and
instructions stored in at least one code block to execute on the processor to perform operations comprising,
storing update code received at the apparatus in at least one data block;
writing pointers identifying storage locations of respective sets of the update code in the patch block; and
performing an update process to update an existing code portion in at least one code block with the update code by using the pointers to locate the respective sets of update code and assemble the update code.

16. The apparatus of claim 15, wherein the memory blocks further include a modification block, and wherein the update process includes assembling update code in the modification block and writing a copy of the modification block to a code block to update the code in the code block.

17. The apparatus of claim 15, further comprising:
an encryption unit coupled to the processor; and
a hash unit coupled to the processor,
wherein a secure flash memory device performs an authentication process on the update code using the encryption unit and the hash unit.

18. The apparatus of claim 15, further comprising a random number generator.

19. The apparatus of claim 15, further comprising random access memory (RAM) coupled to the processor to store a buffer in which portions of the update code are assembled.

20. The apparatus of claim 15, further comprising:
a public key; and
a private key stored in the flash memory.

21. A mobile device, comprising:
a first processor;
a radio frequency (RF) interface including an antenna, coupled to the first processor;
a first memory, coupled to the first processor; and
a secure flash memory, coupled to the first processor and including
a second processor;
a plurality of flash memory blocks coupled to the second processor and logically partitioned into code blocks, data blocks, and a patch block;
a second memory, coupled to the second processor; and
a first set of instructions stored in at least one code block to execute on the second processor to perform operations comprising,
storing update code received at the mobile device in at least one data block;
writing pointers identifying storage locations of respective sets of the update code in the patch block; and
performing an update process to update an existing code portion in at least one code block with the update code by using the pointers to locate the respective sets of update code and assemble the update code.

22. The mobile device of claim 21, wherein the secure flash memory further includes:
an encryption unit coupled to the second processor; and
a hash unit coupled to the second processor,
wherein execution of the first set of instructions performs an authentication process on the update code using the encryption unit and the hash unit.

23. The mobile device of claim 21, further comprising a second set of instructions stored in at least one code block, to be executed on the first processor to perform operations comprising:
receiving an RF transmission containing an update package;
extracting a differential file from the update package; and
forwarding differential file entries in the differential file to the secure flash memory.

24. A machine-readable medium to provide instructions to be executed on a processor of an apparatus including a plurality of flash memory blocks coupled to the processor and logically partitioned into code blocks, data blocks, and a patch block, execution of the instructions to perform operations comprising:
storing update code received at the apparatus in at least one data block;
writing pointers identifying storage locations of respective sets of the update code in the patch block; and
performing an update process to update an existing code portion in at least one code block with the update code by using the pointers to locate the respective sets of update code and assemble the update code.

25. The machine-readable medium of claim 24, wherein the memory blocks further include a modification block, and wherein the update process includes assembling update code in the modification block and writing a copy of the modification block to a code block to update the code in the code block.

26. The machine-readable medium of claim 24, wherein the apparatus further includes an encryption unit and a hash unit coupled to the processor, and wherein execution of the instructions performs an authentication process on the update code using the encryption unit and the hash unit.
